(19) United States
(12) Patent Application Publication
(10) Pub. No.: US 2003/0015536 A1
(43) Pub. Date: Jan. 23, 2003

(54) Fuel tank

(76) Inventors: Daniel R. Tekulve, Batesville, IN (US); James E. Hoffman, Greensburg, IN (US)

Correspondence Address: R. Randall Frisk, Woodard, Emhardt, Naughton, Moriarty and McNett, Bank One Center/Tower, 111 Monument Circle, Suite 3700, Indianapolis, IN, 46204-5137, US

(21) Appl. No.: 09/909,683

(22) Filed: Jul. 20, 2001

(51) Int. Cl. B60P 3/00; B62D 33/00; B65D 88/12

(52) U.S. Cl. 220/562

(57) ABSTRACT

A fuel tank mountable to a machine with an engine includes a body with at least one wall and at least a first boss integrally formed with the one wall and extending outwardly therefrom, the at least a first boss having an exterior surface configured for mating, locking attachment to a ratainer; a bracket having first and second sides and being connectable to one of the machine and the engine, the bracket having a hole sized to receive a boss therethrough with the body adjacent the first side of the bracket; and, a retainer sized and configured for mating, locking attachment to the at least a first boss adjacent the second side of the bracket.

### FIELD OF THE INVENTION

The present invention relates to the field of fuel tanks, and more particularly to an improved fuel tank and method for mounting same to a vehicle.

### BACKGROUND OF THE INVENTION

Riding lawn mowers, both residential and light and heavy duty commercial grade, include fuel tanks mounted somewhere in close proximity to the engine. A number of factors are taken into account when designing the shape, size, composition, location and manner of mounting the fuel tank. It is desirable, for example, to mount the fuel tank close enough to the engine to avoid a long fuel line that must be protected from accidental puncture or rupture. It is also desirable to design the mower as compact as possible, meaning that the fuel tank may be oddly shaped to fit between or next to oddly shaped components. The fuel tank is also usually positioned to the outside of most other components so that it is easily accessible for filling. When components hidden by the fuel tank need servicing, however, the tank will often need to be removed. The means for attaching the fuel tank to the mower should therefore afford easy removal. On the other hand, the attaching means should securely and reliably hold the tank in the desired position. Some methods of attachment currently in use allow the tank to become loose over time from the mower's inherent vibration. Other methods of attachment are difficult to access or undo to remove the tank for maintenance. To ensure that the fuel tank remains tightly secured to its engine, some methods of attachment are complex, costly and difficult or awkward to assemble.

A variety of other engine-driven machines also have fuel tanks with similar design considerations. Such machines may be drivable, such as tractors, go-carts, and the like, or they may be stationary, such as compressors, pressure washers, and the like. All may benefit from an improved fuel tank design.

What is needed is an fuel tank and method for attachment of the tank to the mower or similar machine that is simple to manufacture, less expensive and easy to assemble.

### SUMMARY OF THE INVENTION

Generally speaking, a fuel tank is provided for a vehicle or stationary machine, the fuel tank having a unitary construction and being easily manufactured and assembled.

A fuel tank mountable to a machine with an engine includes a body with at least one wall and at least a first boss integrally formed with the one wall and extending outwardly therefrom, the at least a first boss having an exterior surface configured for mating, locking attachment to a ratainer; a bracket having first and second sides and being connectable to one of the machine and the engine, the bracket having a hole sized to receive a boss therethrough with the body adjacent the first side of the bracket; and, a retainer sized and configured for mating, locking attachment to the at least a first boss adjacent the second side of the bracket.

It is an object of the present invention to provide an improved fuel tank.

Other objects and advantages of the present invention will become apparent from the following description of the preferred embodiment.

### BRIEF DESCRIPTION OF THE DRAWINGS

FIG. 1 is a front perspective view of a riding lawn mower 11 with improved fuel tank 10 in accordance with the preferred embodiment of the present invention.

FIG. 2 is a rear perspective view of the riding lawn mower 11 of FIG. 1.

FIG. 3 is a side cross-sectional view of the fuel tank 10 of the mower 11 of FIG. 1.

FIG. 4 is an exploded perspective view of the fuel tank 10 of the mower 11 of FIG. 1.

FIG. 5 is a perspective view of a portion of the mower 11 of FIG. 1 showing the mounting brackets 58 and 59 for fuel tank 10.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and that any alterations or modifications in the illustrated device, and any further applications of the principles of the invention as illustrated therein are contemplated as would normally occur to one skilled in the art to which the invention relates.

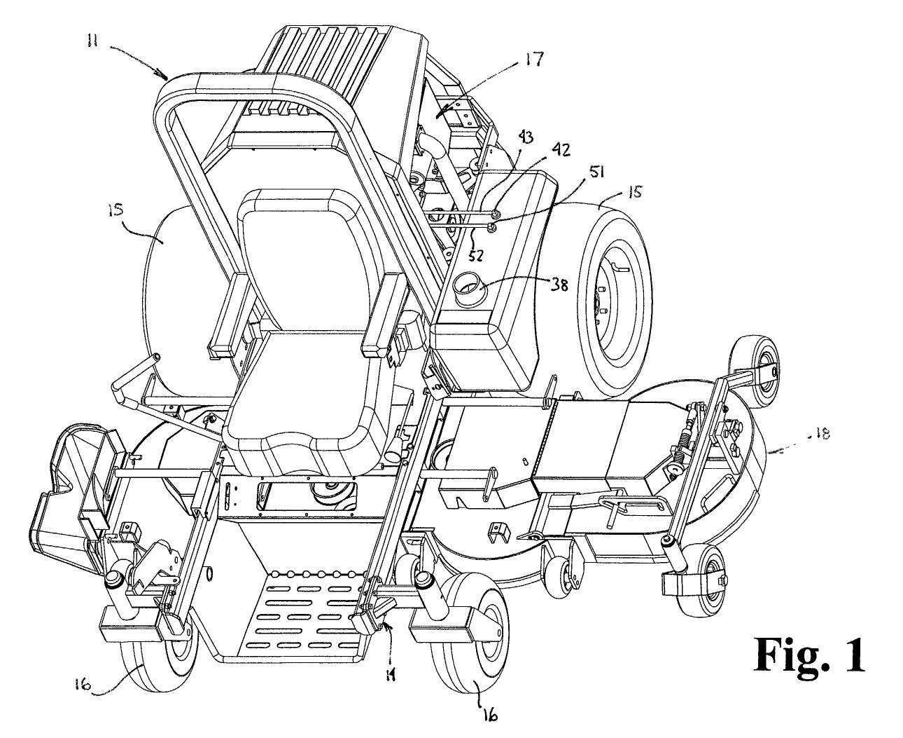

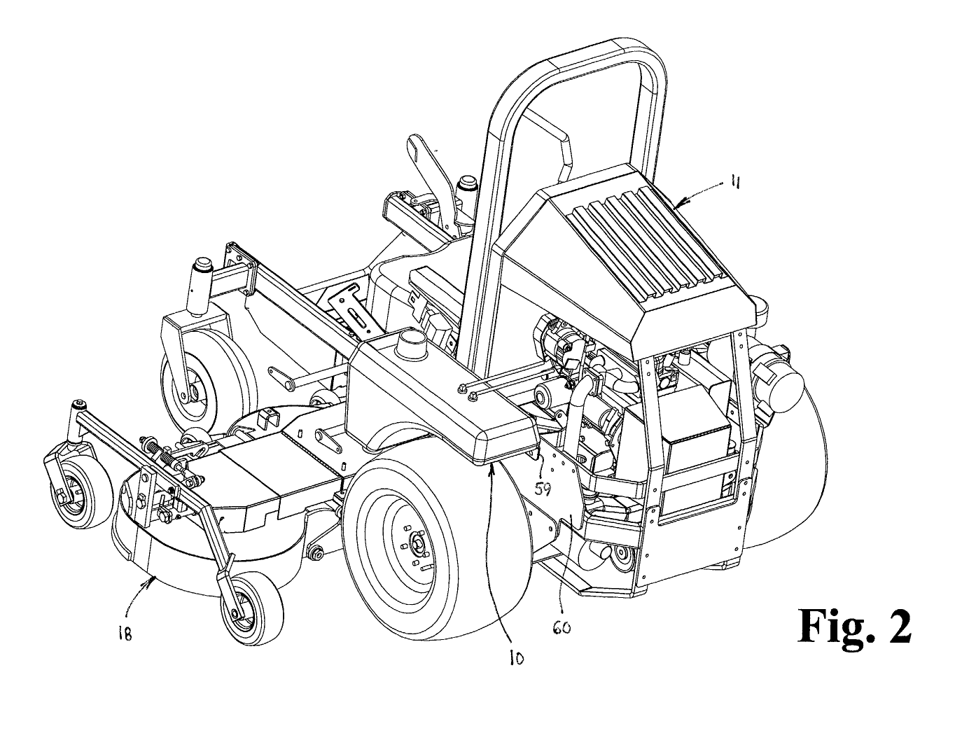

Referring now to FIGS. 1 and 2, there is shown a fuel tank 10 connected with a lawn mower 11 in accordance with the preferred embodiment of the present invention. As with known riding lawn mowers, mower 10 generally includes a frame 14, rear wheels 15, front wheels 16, an engine 17, one or more cutting decks 18, an operator seat 19, and various other controls and attachments.

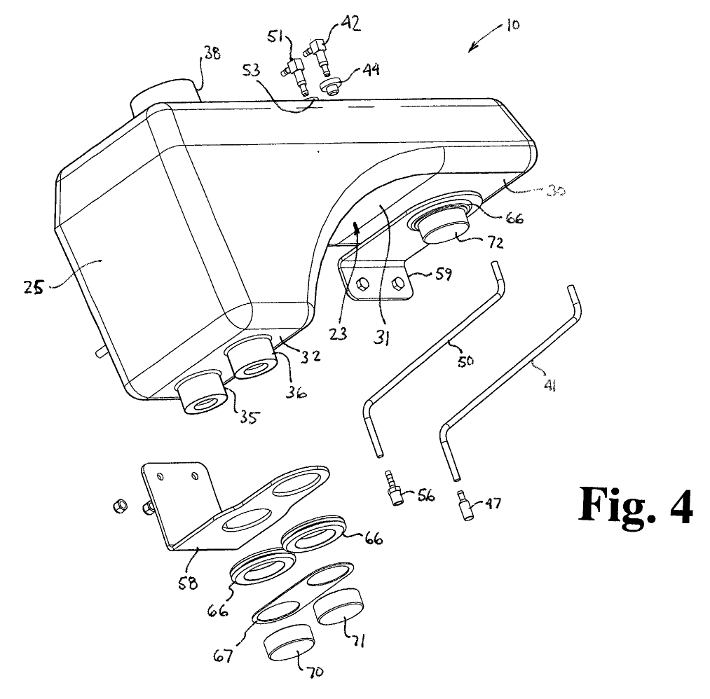

Referring now to FIGS. 1-4, fuel tank 10 is shaped generally as shown to be mounted on the left side of mower 11 and above the left rear wheel 15. To optimize this available space, fuel tank 10 has a generally flat upper wall 22 and a lower wall 23 that curves downwardly to form a lower well 24 along with front side wall 25 and opposing inner and outer side walls 26 and 27. Lower wall 23 includes a generally flat rear portion 30, a curved central portion 31, and a lower, generally flat front portion 32. A pair of cylindrically shaped mounting bosses 35 and 36 extend downwardly from front lower portion 32, and a cylindrically shaped mounting boss 37 extends downwardly from rear portion 30. A filler neck 38 extends upwardly from upper wall 22. Fuel tank 10 is made of polypropylene or any appropriate plastic appropriate for holding petrochemicals. Fuel tank 10, including mounting bosses 35-37, filler neck 38, and the various walls 22, 23, and 25-27 are formed by rotational-molding. Other forms of manufacture of fuel tank 10 are also contemplated, such as blow-molding.

Fuel tank 10 further includes a fuel suction tube 41 with a fitting 42 attached at its upper end, fitting 42 is then connected with a fuel supply line 43 leading to engine 17. A grommet 44 is provided to firmly mount and seal fitting 42 in an opening 46 defined in upper wall 22 of tank 10. A filter screen 47 is connected at the bottom end of suction tube 41 to prevent pulling solid particulate matter through the fuel system.

In the present embodiment, engine 17 is a diesel engine, and fuel tank 10 therefore also includes a return fuel tube 50 with a fitting 51 for connection with the return fuel line 52, and with a grommet 53 for mounting and sealing fitting 51 in the opening 55 defined in upper wall 22. A weighted, push-on barbed fitting 56 is attached to the bottom end of return fuel tube 50 to weight tube 50 down and keep it in the bottom of lower well 24.

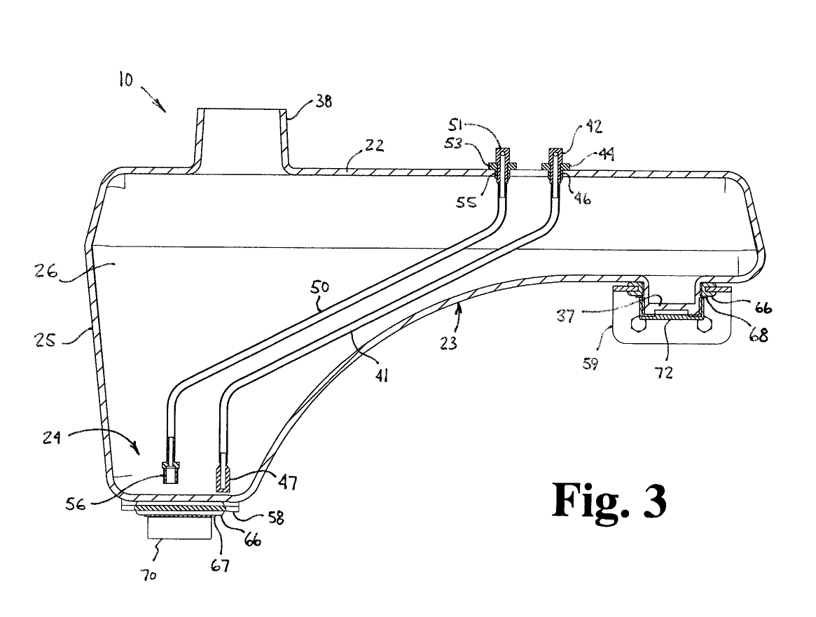

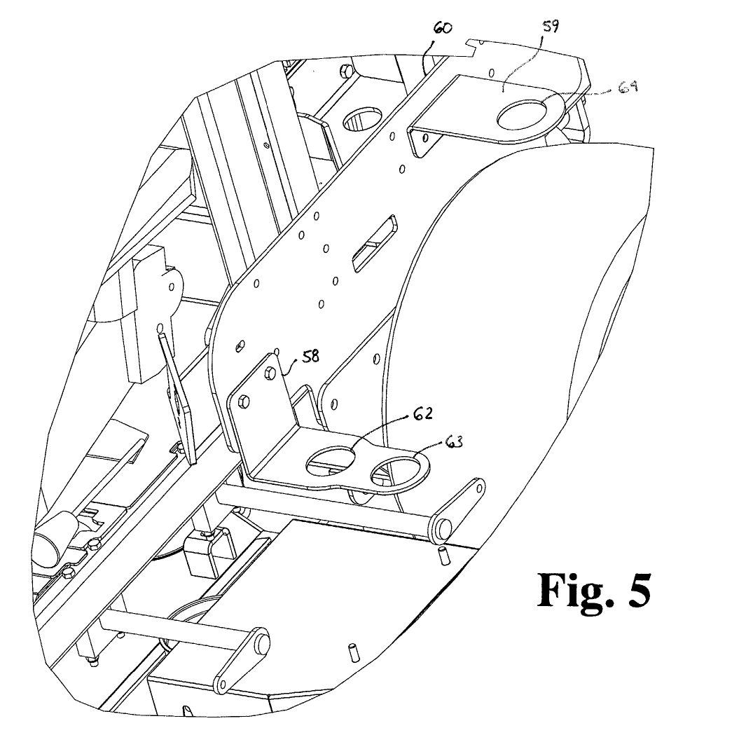

Referring to FIGS. 3-5, a pair of L-shaped mounting brackets 58 and 59 are attached by appropriate means such as screws to a mounting plate 60 of mower frame 14. Forward mounting plate 58 defines a pair of mounting holes 62 and 63 sized and positioned to receive mounting bosses 35 and 36 therethrough. Rear mounting bracket 59 defines a mounting hole 64 sized and positioned to receive rear mounting boss 37 therethrough. A grommet 66 is received within each hole 62-64 end around each mounting boss 35-37 to provide a snug and cushioned attachment between brackets 58 and 59 and fuel tank 10. A two-hole washer is positioned up against the lower side of grommet 66 and around bosses 35 and 36. Likewise, a washer 68 is received up against the lower surface of grommet 66 and around boss 37. Each of bosses 35-37 is molded with external buttress threads, and retainers, such as internally threaded end caps 70-72, are threadedly received onto mounting bosses 35-37 to tightly connect fuel tank 10 to brackets 58 and 59. Caps 70-72 are contemplated to have other configurations so long as they mate with and can be securely engaged with the ends of bosses 35-37. In the present embodiment, bosses 35-37 and caps 70-72 are disclosed to have buttress threads. Other embodiments are contemplated, such as a pin and slot arrangement.

Mower 11 is shown with just one fuel tank 10. The present invention contemplates that mower 11 have a second fuel tank 10 mounted on the other side, above the right rear wheel. Also, it is contemplated that fuel tank 10 be made in other shapes and sizes to accommodate and corresponde to the the particular space that is available for receiving the fuel tank.

Fuel tank 10 is shown with three bosses extending outwardly from the lower wall 23. Other embodiments contemplate that there be fewer or more bosses extending outwardly, and of shapes other than cylindrical. The bosses could extend from other than the lower wall. For example, just one boss could extend from the lower wall and one boss could extend from an upper wall. Alternatively, fuel tank 10 could be designed to sit on a bracket or other surface, and a boss extending from the inner side wall 26 could engage with a mating attachment bracket to securely hold the tank in place. Still another of many possible configurations includes a single, somewhat larger boss extending down from the lower wall and engaging in a complementary-shaped opening defined by an element connected to the mower frame.

While the invention has been illustrated and described in detail in the drawings and foregoing description, the same is to be considered as illustrated and not restrictive in character, it being understood that only the preferred embodiment has been shown and described and that all changes and modifications that come within the spirit of the invention are desired to be protected.

What is claimed is:

1. A fuel tank mountable to a machine with an engine, comprising:
a body with at least one wall and at least a first boss integrally formed with the one wall and extending outwardly therefrom, the at least a first boss having an exterior surface configured for mating, locking attachment to a ratainer;
a bracket having first and second sides and being connectable to one of the machine and the engine, said bracket having a hole sized to receive a boss therethrough with said body adjacent the first side of said bracket; and,
a retainer sized and configured for mating, locking attachment to the at least a first boss adjacent the second side of said bracket.
